(19) United States
(12) Patent Application Publication
(10) Pub. No.: US 2012/0005500 A1
(43) Pub. Date: Jan. 5, 2012

(54) PERIPHERAL-DEVICE UTILIZING SYSTEM, SERVER DEVICE, AND METHOD

(75) Inventor: Nobuhiro Tamura, Nagoya-shi (JP)

(73) Assignee: BUFFALO INC., Nagoya-shi (JP)

(21) Appl. No.: 13/162,587

(22) Filed: Jun. 17, 2011

(30) Foreign Application Priority Data
Jun. 30, 2010 (JP) 2010-149092

(51) Int. Cl. G06F 13/14; G06F 15/16; G06F 1/32

(52) U.S. Cl. 713/320; 710/33; 709/217

(57) ABSTRACT

A server machine, connectable to a peripheral device and to a client machine via a network, includes: a device interface for connecting with a peripheral device; a network interface for connecting with a network; and a device interface control section configured to relay data communications between the client machine and the peripheral device via the device interface and the network interface, and to execute a first process, if a first condition, including that predetermined first data has been received from the client machine is satisfied, of causing the peripheral device to transition into a first state in which the peripheral device is communicable with the server machine, and execute a second process, if a second condition, including that predetermined second data has been received is satisfied, of causing the peripheral device to transition into a second state in which its power consumption is lower than that in the first state.

### CROSS REFERENCE TO RELATED APPLICATION

The disclosure of Japanese Patent Application No. 2010-149092, filed on Jun. 30, 2010, is incorporated herein by reference.

### BACKGROUND OF THE INVENTION

1. Field of the Invention

The present invention relates to peripheral-device utilizing systems, server machines, and methods.

2. Description of the Background Art

As server machines that allow computers to use USB (universal serial bus) devices via networks, USB device servers have been known to date. And as disclosed in Japanese Laid-Open Patent Publication No. 2007-310796, for example, technology according to which when a computer uses a USB device, a USB device server puts the state of the USB bus power into an ON condition, and after a predetermined time period has elapsed, the USB device server puts the state of the USB bus power into an OFF condition has been proposed.

The current situation, however, concerning technology for utilizing peripheral devices such as USB devices is that sufficient innovation has yet to come about. For example, with the technology that at the start of USB device use puts the USB's bus-power state into an ON condition from an OFF condition, the wait time until readying of the USB device is complete when a USB device is to be used can be long and thus convenience can deteriorate. And with technology that maintains a USB's bus power constantly in an ON condition, the cumulative figure for the consumed power can be excessive.

It will be appreciated that such problems have not been limited to cases where the interface standard for the peripheral devices is a USB standard; the problems have been common to cases where the interface standard is another standard.

### SUMMARY OF THE INVENTION

An object of the present invention is to make available a server machine that when a peripheral device is to be used can keep the cumulative consumed power figure to a minimum, while reducing the wait time until readying the peripheral device is complete.

A first aspect of the present invention is a system whereby a client machine uses a peripheral device, the system comprising a peripheral device, a server machine that connects to the peripheral device, and at least one client machine that connects to the server machine via a network. The server machine includes: a device interface for connecting with the peripheral device, a server machine network interface for connecting with a network, and a device interface control section for relaying data communications between the client machine and the peripheral device via the device interface and the server machine network interface. The client machine includes: a client machine network interface for connecting with the network, a virtual interface control section for, via the client machine network interface and the server machine network interface, communicating with the device interface control section and setting up a virtual device interface having an access configuration identical with that of the device interface, and an operational state data transmitting section for transmitting predetermined first data to the server machine at launch of the client machine, and for transmitting predetermined second data to the server machine at shut-down of the client machine. The device interface control section is configured to execute a first process if a first condition, including that the first data has been received from the client machine, is satisfied, of causing the peripheral device to transition into a first state in which the peripheral device is communicable with the server machine, and execute a second process if a second condition, including that the second data has been received from the client machine, is satisfied, of causing the peripheral device to transition into a second state in which its power consumption is lower than that in the first state.

In a further aspect, it is preferable that the device interface includes a power supply terminal for supplying electric power to the peripheral device; and the device interface control section is configured to execute as the first process a process of starting supply of electric power to the power supply terminal, and execute as the second process a process of stopping supply of electric power to the power supply terminal.

In a further aspect, it is preferable that the device interface control section is configured execute the first process, with the first condition being that the first data has been received in a state in which the operational state of the peripheral device is the second state; and execute the second process with the second condition being that a value in which, upon the second data being received, a count of times the second data has been received is subtracted from a count of times the first data has been received has become zero.

A second aspect of the present invention is a method whereby a client machine utilizes a peripheral device, in a system comprising a peripheral device, a server machine that connects to the peripheral device, and at least one client machine that connects to the server machine, wherein at launch of the client machine: the client machine transmits first data to the server machine; the server machine executes a first process, if a first condition, including that the first data has been received from the client machine, is satisfied, of causing the peripheral device to transition into a first state in which the peripheral device is communicable with the server machine; and the client machine sets up, through communication with the server machine, a virtual device interface having an protocol identical with that of a device interface included in the server machine, and at shutdown of the client machine: the client machine transmits second data to the server machine via the network; and the server machine executes a second process, if a second condition, including that the second data has been received from the client machine, is satisfied, of causing the peripheral device to transition into a second state in which its power consumption is lower than that in the first state.

A third aspect of the present invention is a server machine that connects to a peripheral device, and that connects to a client machine via a network, including: a device interface for connecting with the peripheral device; a network interface for connecting with a network; and a device interface control section configured to relay data communications between the client machine and the peripheral device via the device interface and the server machine network interface, and execute a first process, if a first condition, including that predetermined first data has been received from the client machine, is satisfied, of causing the peripheral device to transition into a first state in which the peripheral device is communicable with the server machine, and execute a second process, if a second condition, including that predetermined second data has been received from the client machine, is satisfied, of causing the peripheral device to transition into a second state in which its power consumption is lower than that in the first state.

In a further aspect, it is preferable that the device interface control section uses, as the first data, a discover message that is transmitted by the client machine and is compliant with a dynamic host configuration protocol.

It should be noted that the present invention can be realized in various modes, and can be realized, for example, in such modes as a method and a server machine which causes a client machine to utilize a peripheral device via a network, a network system including the server machine and the client machine, a computer program for realizing the method or functions of the device, and a storage medium having stored therein the computer program.

According to the present invention, it is possible to provide a server machine that when a peripheral device is to be used can keep the cumulative consumed power figure to a minimum, while reducing the wait time until readying the peripheral device is complete. The present invention is applicable to device servers which are connectable to peripheral devices such as USB devices, and usefully facilitate convenience in the case where, for example, a computer establishes a connection with a device server to utilize a peripheral device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a system according to a first embodiment of the present invention;

FIG. 2 is a sequence diagram illustrating a process performed by the system at the time of startup (power ON) of a computer according to the first embodiment of the present invention;

FIG. 3 is a sequence diagram illustrating an outline of a process performed by the system at the time of shutdown (power OFF) of the computer according to the first embodiment of the present invention;

FIG. 4 is a block diagram illustrating a system 910 according to a second embodiment of the present invention; and

FIG. 5 is a flowchart illustrating a process performed by a device interface control section according to the second embodiment of the present invention.

### DESCRIPTION OF THE PREFERRED EMBODIMENTS

### First Embodiment

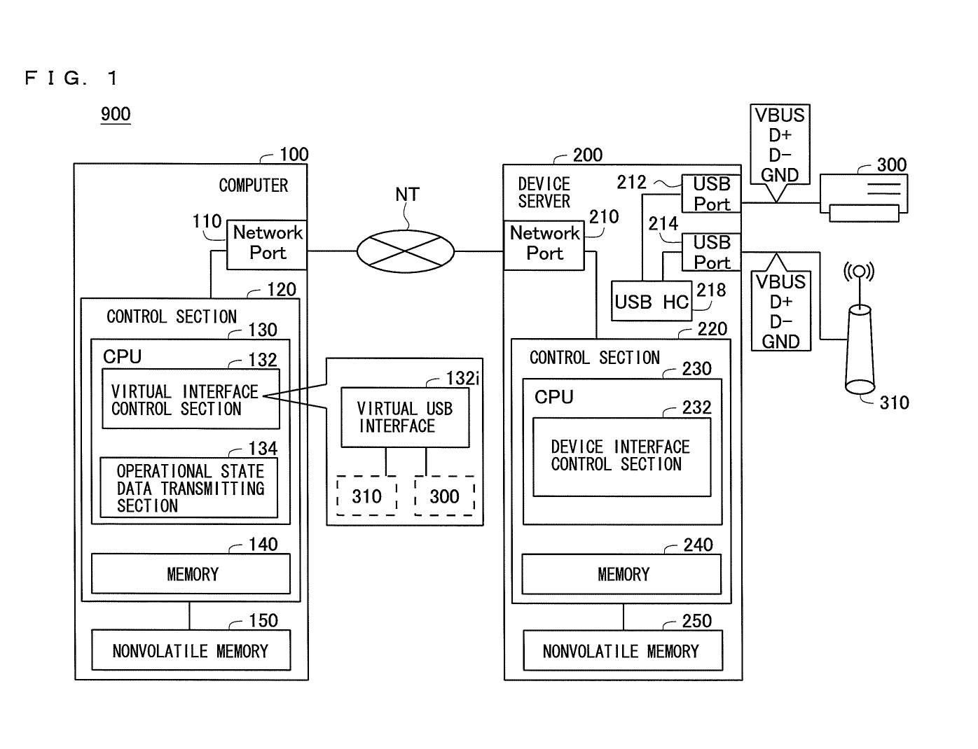

A first embodiment of the present invention will be described. FIG. 1 is a block diagram illustrating a system 900 according to a first embodiment of the present invention. The system 900 includes a computer 100, a device server 200, a printer 300, and a TV tuner 310. The computer 100 is a general-purpose personal computer which is connectable as a client machine to the device server 200. The computer 100 is connected to the device server 200 via a network NT. The printer 300 and the TV tuner 310 are each connected to the device server 200. A network including a relay device such as a hub or a router may be adopted as the network NT. Alternatively, a communication line directly connecting the computer 100 and the device server 200 may be adopted as the network NT. In this embodiment, the computer 100, the device server 200, the printer 300, and the TV tuner 310 are arranged close to one another (for example, these devices 100, 200, 300, and 310 are arranged in a common room). Otherwise, some of the devices may be arranged away from the remaining devices.

The computer 100 includes a network port 110 which is a network interface for connection with a network, a control section 120, and a nonvolatile memory 150 (e.g., a hard disk drive or a solid-state drive). The network port 110 is, for example, a physical interface (physical port) in conformance to the Ethernet (registered trademark). The control section 120 includes a CPU 130 and a memory 140 (e.g., DRAM), and the CPU 130 controls components in the computer 100. The CPU 130 executes a program stored in the nonvolatile memory 150 to realize functions of various process sections including a virtual interface control section 132 and an operational state data transmitting section 134 (details to be described later). Hereinafter, execution of a function by the CPU 130 as a certain process section in the computer 100 according to the program will be also referred to as execution of a process by the process section.

The device server 200 is a server machine that is configured to relay communication between a peripheral device and a computer so as to cause the computer to utilize the peripheral device via a network. In this embodiment, a peripheral device that conforms with the USB (Universal Serial Bus) standard is adopted. The device server 200 includes a network port 210 which is a network interface for connection with a network, USB ports 212 and 214 which are device interfaces for connection with devices in conformance to the USB standard, a USB host controller 218, a control section 220, and a nonvolatile memory 250 (e.g., flash memory). The network port 210 is, for example, a physical interface (physical port) in conformance to the Ethernet (registered trademark). The USB ports 212 and 214 are physical interfaces (physical ports) in conformance to the USB standard. The USB host controller 218 is a host controller in conformance to the USB standard, and controls the USB ports 212 and 214. The control section 220 includes a CPU 230 and a memory 240 (e.g., DRAM), and controls respective components of the device server 200. The CPU 230 executes a program stored in the nonvolatile memory 250 to realize a function as a device interface control section 232. Hereinafter, execution of a function by the CPU 230 as a certain process section in the device server 200 according to the program will be also referred to as execution of a process by the process section. The device interface control section 232 controls the USB ports 212 and 214 via the USB host controller 218 so as to control USB devices and communicate with USB devices (details to be described later).

The printer 300 and the TV tuner 310 are peripheral devices in conformance to the USB standard. In the system 900 illustrated in FIG. 1, the printer 300 is connected to the first USB port 212, and the TV tuner 310 is connected to the second USB port 214. The USB ports 212 and 214 each have four terminals (VBUS, D+, D−, GND) in conformance to the USB standard. The GND terminal provides a reference potential (common reference), the VBUS terminal provides electric power to USB devices, and the D+ terminal and the D− terminal perform signal (data) input/output.

The virtual interface control section 132 of the computer 100 carries out communication with the device interface control section 232 of the device server 200 via the network NT to establish a virtual USB interface 132i (e.g., the virtual interface control section 132 establishes a virtual route hub (USB host controller) and a virtual USB port). The virtual interface control section 132 and the device interface control section 232 transfer/receive to/from each other data for controlling USB devices (the printer 300 and the TV tuner 310, in this case) by encapsulating the data with a packet for network communication.

The virtual interface control section 132 allows an application (e.g., a device driver for USB devices) being activated on the computer 100 to access the virtual USB interface 132i. The manner in which an application accesses the virtual USB interface 132i is the same as the manner in which an application accesses general USB interfaces (USB host controller). Accordingly, the application can utilize USB devices connected to the device server 200 as USB devices that are directly connected to the virtual USB interface 132i.

For example, a case where the computer 100 executes printing by means of the printer 300 will be described. In this case, an application (e.g., a word processor, and a device driver for the printer 300) being activated on the computer 100 supplies the virtual interface control section 132 with control data (including print data in this example) for controlling a USB interface. The virtual interface control section 132 encapsulates the received control data and transmits the encapsulated control data to the device server 200. The device interface control section 232 of the device server 200 extracts the control data for controlling USB interface from the received encapsulated control data. The device interface control section 232 controls the USB host controller 218 according to the extracted control data to supply print data included in the control data to the printer 300 through the first USB port 212. The printer 300 executes printing according to the received print data.

Next, a case will be described where the computer 100 displays a TV program (moving images) received by the TV tuner 310 will be described. In this case, the TV tuner 310 outputs to the second USB port 214 control data (including moving image data representing the received moving images, in this example) for controlling a USB interface. Upon reception of the control data from the second USB port 214, the USB host controller 218 supplies the device interface control section 232 with the received control data. The device interface control section 232 encapsulates the received control data and transmits the encapsulated control data to the computer 100. The virtual interface control section 132 of the computer 100 extracts the control data for controlling the USB interface from the received encapsulated control data, and supplies the extracted control data to an application being activated on the computer 100 (in this example, a device driver for the TV tuner 310 and a moving image reproduction application). The device driver obtains moving image data from the received control data, and supplies the obtained moving image data to the moving image reproduction application.

As described above, the virtual interface control section 132 and the device interface control section 232 realize bidirectional communication in accordance with the USB standard. Further, the virtual interface control section 132 and the device interface control section 232 realize not only communication with the printer 300 or the TV tuner 310, but also communication with various USB devices.

Any method that realizes USB communication between the computer 100 and USB devices may be adoptable as a method of communication between the virtual interface control section 132 and the device interface control section 232. For example, the device interface control section 232 may transmit to the computer 100 only data that the computer 100 requires, among various data transmitted/received between the device server 200 and USB devices.

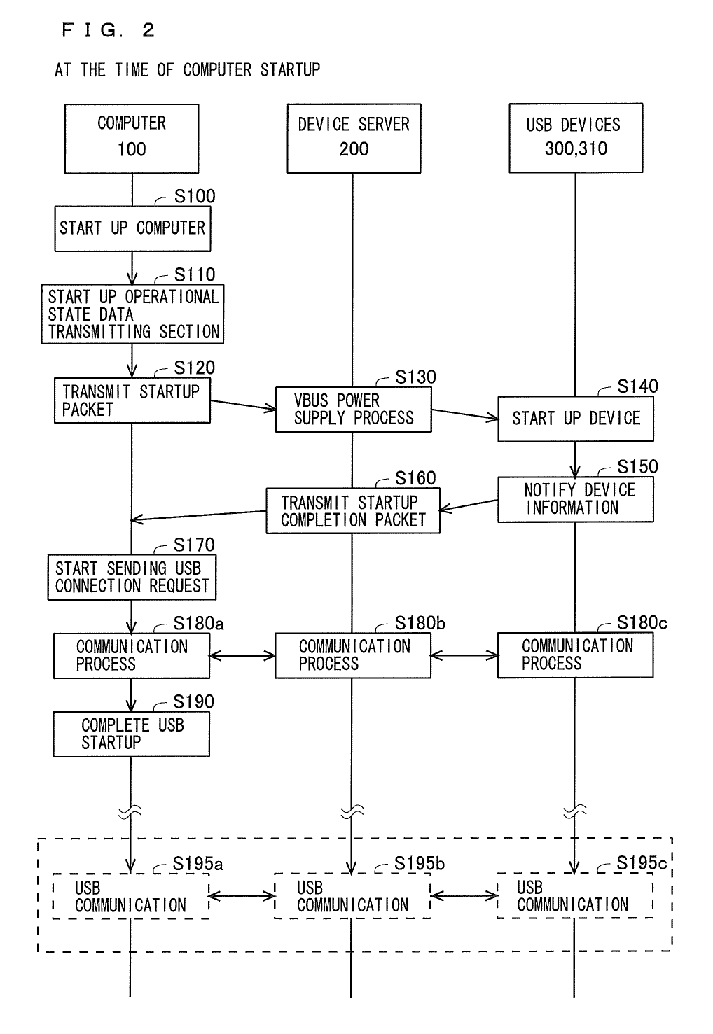

FIG. 2 is a sequence diagram showing an outline of a process performed at the time of startup (power ON) of the computer 100. Before startup of the computer 100, the device server 200 (USB host controller 218) stops electric power supply from the VBUS terminals of the USB ports 212 and 214 (FIG. 1). Accordingly, the power consumption by USB devices connected to the USB ports 212 and 214 is reduced as compared to a case where electric power is supplied from the VBUS terminal (hereinafter, this state the USB devices is in is also referred to as a “second state”).

In step S100, according to a user's operation, the computer 100 starts a startup process (the user turns on the power of the computer 100). In step S110, the operational state data transmitting section 134 automatically starts up, and in step S120, the operational state data transmitting section 134 transmits a startup packet to the device server 200. The startup packet includes predetermined data (hereinafter also referred to as “first data”). The first data is different from data to be supplied to the USB devices (USB control data). The device interface control section 232 of the device server 200 will not transmit the received first data to the USB devices. Accordingly, the first data is not used for processes in the USB devices, but is used for a process in the device interface control section 232.

In step S130, in response to reception of the first data, the device interface control section 232 of the device server 200 causes the USB host controller 218 to start supplying electric power to the VBUS terminals of all the USB ports (USB ports 212 and 214). In step S140, USB devices (the printer 300 and the TV tuner 310 in this case) connected to the USB ports 212 and 214 are all started up using the supplied electric power to start communication with the device server 200. In this manner, the device interface control section 232 sets the state of each USB device connected to the device server 200 to be communicable with the device server 200 (hereinafter also referred to as a “first state”). Here, “the state of the USB devices as being communicable with the device server 200” means the state in which one of either each USB device or the device interface control section 232 of the device server 200 transmits any data to the other, and the other executes a process according to the data. In subsequent step S150, the device interface control section 232 and the USB host controller 218 start a so-called bus enumeration to obtain various information relating to the USB devices. In step S160, the device interface control section 232 transmits to the computer 100 a packet including data that indicates completion of startup of the USB devices (referred to as “startup completion data”). The startup completion data is not control data in conformance to the USB standard, but is used for a process by the virtual interface control section 132 in the computer 100.

In step S170, upon reception of the startup completion data, the virtual interface control section 132 in the computer 100 starts sending connection request to the USB devices. In subsequent steps S180a to S180c, communication between the computer 100 and the device server 200 and communication between the device server 200 and each USB device are carried out. The communications are made to establish data communication between the computer 100 and the USB devices. In step S190, data communication between the computer 100 and the USB devices via the device server 200 is established. For example, a logical communication path (also referred to as a “pipe” according to the USB standard) between an application (e.g., a device driver) being activated on the computer 100 and each USB device is established via the device server 200. Communication paths of this sort are established for respective functions of the USB devices. As described above, the virtual interface control section 132 carries out communication for enabling use of various functions of the USB devices via the device interface control section 232 of the device server 200.

Accordingly, the device interface control section 232 virtually realizes the state of the USB device as being connected to the computer 100. An application being activated on the computer 100 (e.g., a word processor) can utilize the USB device without recognizing the presence of the device server 200. When a plurality of USB devices are connected to the device server 200, the communication paths are established between the computer 100 and all of the plurality of USB devices. The above-described process is referred to as a first process.

Thereafter until the computer 100 is shut down, the logical communication path (pipe) between the computer 100 and each USB device is maintained. Accordingly, until the computer 100 is shut down, communication between the computer 100 and each USB device can be started promptly (steps S195a to S195c). As a result, if the application being activated on the computer 100 is to utilize any of the USB devices, a possible excessively long wait time until readying the peripheral device is complete can be reduced.

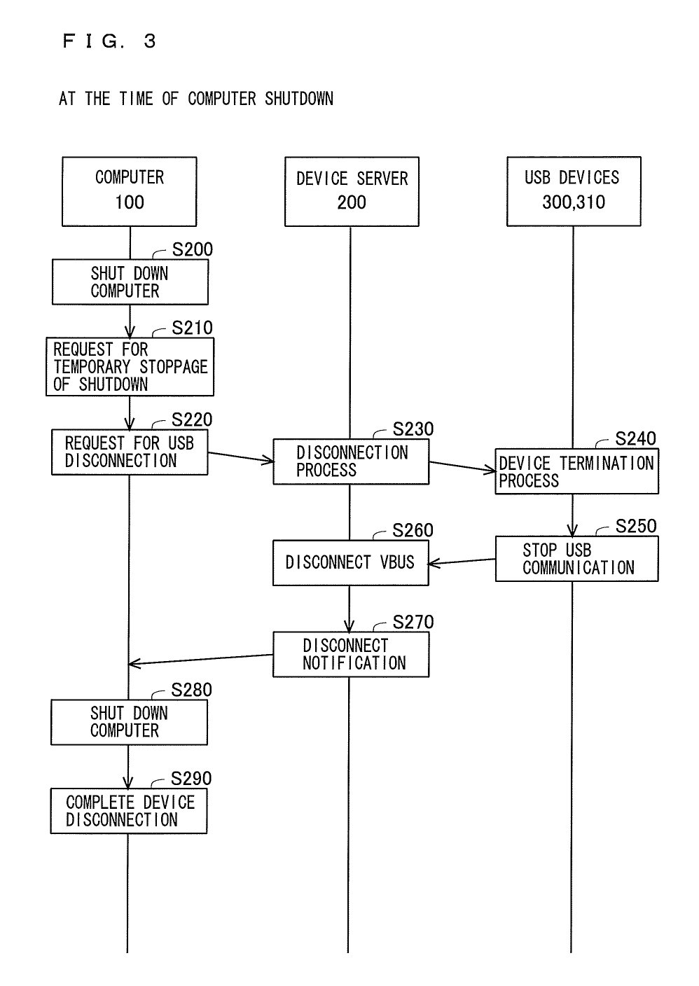

FIG. 3 is a sequence diagram illustrating an outline of a process performed by the system at the time of shutdown (power OFF) of the computer 100. In step S200, according to the user's operation, the computer 100 starts a shutdown process (the user turns off the power of the computer 100). In step S210, the operational state data transmitting section 134 (FIG. 1) sends a request for a temporary stop of the shutdown process to the operation system of the computer 100. In step S220, the operational state data transmitting section 134 transmits a USB device disconnection request to the device server 200. Here, a packet including predetermined data (data different from the first data, hereinafter also referred to as “second data”) is used as a disconnection request. The second data is different from data (control data in conformance to the USB standard) to be supplied to the USB device. The device interface control section 232 of the device server 200 does not transmit second data to the USB device. Thus, the second data is not used for a process in the USB device, but used for a process in the device interface control section 232.

In step S230, upon reception of the second data, the device interface control section 232 starts a process of disconnecting communication with all the USB devices. For example, the device interface control section 232 causes the buses of all the USB ports to transition into a suspend state. Accordingly, in step S240, all the USB devices connected to the device server 200 transition into the suspend state. In step S250, all the USB devices stop USB communication. In response, in step S260, the device interface control section 232 stops supplying electric power to the VBUS terminals of all the USB ports. Accordingly, the device interface control section 232 changes the power consumption of the USB devices (in this case, the printer 300 and the TV tuner 310) connected to the device server 200 to the suspend state (second state), as compared to a case where electric power is supplied to the USB devices from the VBUS terminals.

In subsequent step S270, the device interface control section 232 notifies the computer 100 that communication with the USB devices is completely disconnected. In step S280, the operational state data transmitting section 134 of the computer 100 restarts the shutdown process in response to the notification from the device server 200. Accordingly, the shutdown process of the computer 100 proceeds, and in step S290, shutdown of the computer completes (communication between the computer 100 and the USB devices is also completely disconnected). It should be noted that step S270 may be omitted. In this case, upon completion of transmission of the second data, the operational state data transmitting section 134 may restart the shutdown process. The above-described process is referred to as a second process.

As described above, the operational state data transmitting section 134 (FIG. 1) of the computer 100 transmits to the device server 200 the first data at the time of startup of the computer 100 (S120 in FIG. 2). Upon reception of the first data, the device interface control section 232 of the device server 200 starts supplying electric power to the VBUS terminals to cause the USB devices to transition into the first state where the USB devices are communicable with the device server 200 (S130 to S150 in FIG. 2). As a result, a possible excessively long wait time until readying the computer 100 is complete can be reduced when the computer 100 utilizes USB devices. In this embodiment, reception of the first data by the device server 200 is a condition (first condition) for changing the state of the USB devices to the first state.

Further, the operational state data transmitting section 134 (FIG. 1) of the computer 100 transmits to the device server 200 the second data at the time of shutdown of the computer 100 (S220 in FIG. 3). Upon reception of the second data, the device interface control section 232 of the device server 200 stops supplying electric power to the VBUS terminals to cause the USB devices to transition into the second state where the power consumption is lower than in the first state (S230 to S260 in FIG. 3). As a result, it is possible to reduce the power consumption under the circumstances where USB devices are not used. In the first embodiment, reception of the second data by the device server 200 is a condition (second condition) for changing the state of the USB devices to the second state.

Further, at the time of startup of the computer 100, the virtual interface control section 132 of the computer 100 establishes data communication with a USB device via the device server 200, and virtually realizes the state of the USB device as being connected to the computer 100 (S170 to S190 in FIG. 2). Accordingly, a possible excessively long wait time until readying the USB device is complete can be effectively reduced when the computer 100 uses a USB device.

### Second Embodiment

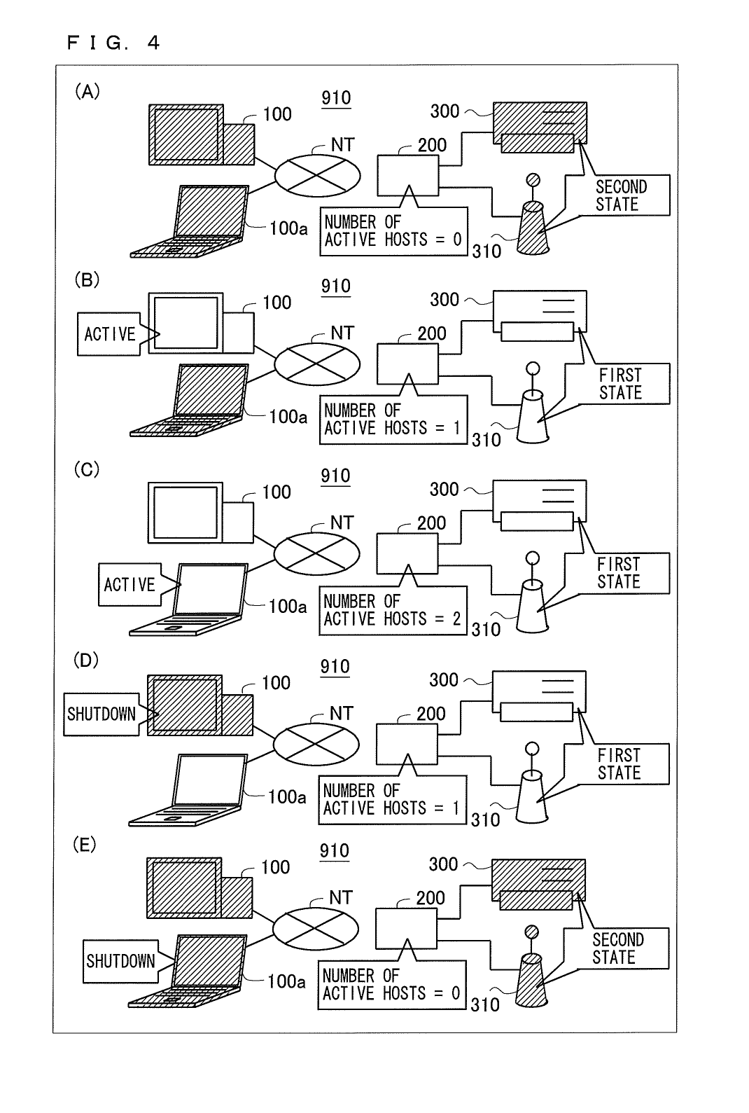

FIG. 4 is a diagram illustrating a system 910 according to a second embodiment. Diagrams (A) to (E) in FIG. 4 illustrate five stages showing how the state of the system 910 transitions (the state transitions in order from (A) to (E) in FIG. 4). The configuration of the system 910 is obtained by adding to the system 900 in FIG. 1 a second computer 100a connected to the network NT. Components of the system 910 which are the same as those of the system 900 in FIG. 1 are denoted by the same reference numerals. In this embodiment, the computer 100 is referred to as a first computer 100. Similarly to the first computer 100, the second computer 100a has the same internal configuration as the computer 100 illustrated in FIG. 1, and thus details thereof will not be given. The computers 100 and 100a are able to utilize USB devices 300 and 310 via the device server 200. In this second embodiment, however, processes executed by respective components are partially different from those in the first embodiment.

In this embodiment, the device interface control section 232 maintains the USB device as being in the first state (state where the USB device is communicable with the device server 200) when the total number of computers being in active is one or more (hereinafter, the total number of computers being in active is also referrers to as “number of active hosts”). When the number of active hosts is “0”, the device interface control section 232 maintains the USB device as being in the second state (state where the power consumption of the USB device is reduced).

The device interface control section 232 calculates the number of active hosts as described below. Each of the computers 100 and 100a transmits the first data to the device server 200 at the time of its startup. In addition, each of the computers 100 and 100a transmits the second data to the device server 200 at the time of its shutdown. The device interface control section 232 of the device server 200 calculates the number of active hosts by subtracting the number of times the device server 200 has received the second data (shutdown data) from the number of times the device server 200 has received the first data (startup data).

In this embodiment, the device server 200 starts up before the computers 100 and 100a start up. Upon starting up of the device server 200, the device interface control section 232 operates while regarding that the number of active hosts is “0”. Diagram (A) in FIG. 4 shows a state where none of the computers 100 and 100a is in active, and the device server 200 is in active. The device server 200 stops supplying electric power to the VBUS terminals of all the USB ports. All the USB devices 300 and 310 are in the second state (state where the power consumption is reduced). It should be noted that the device interface control section 232 may use a value set by a user as an initial value of the number of active hosts.

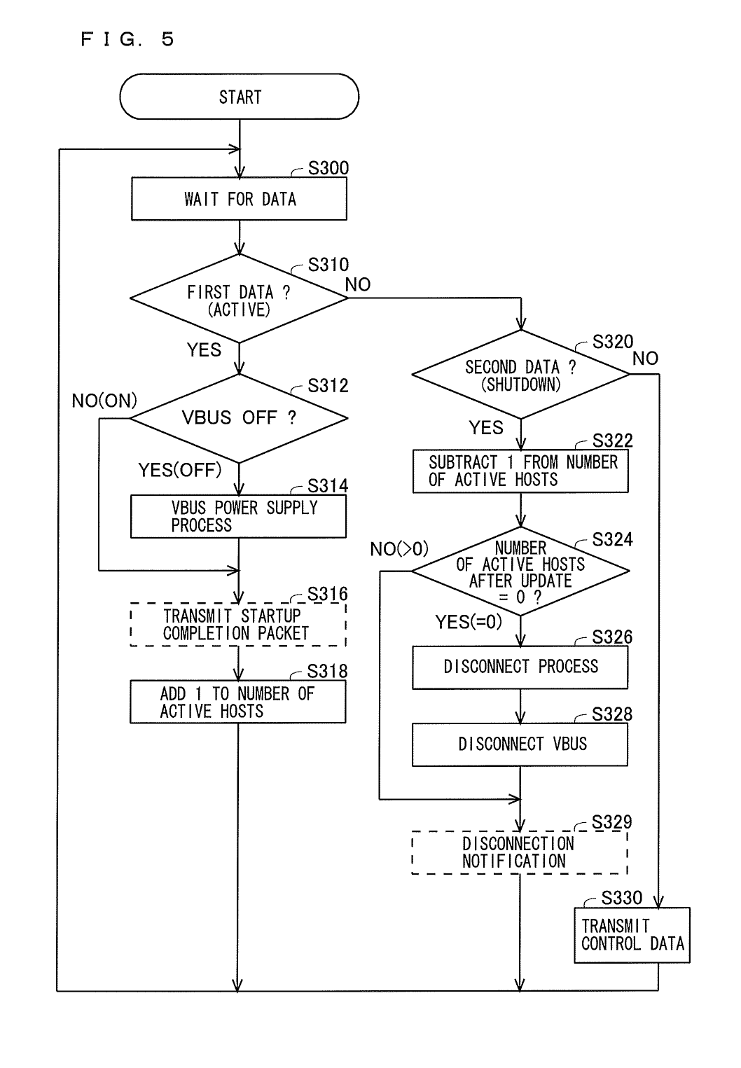

FIG. 5 is a flowchart showing the procedure of a control process executed, when the device server 200 has received data from the computer 100 or 100a, by the device interface control section 232 according to the data. The types of data are the first data, the second data, and control data for controlling USB devices. In first step S300, the device interface control section 232 waits for reception of data by the device server 200 transmitted from the computer 100 or 100a. Upon reception of data, in step S310, the device interface control section 232 (FIG. 1) determines whether the received data is the first data.

If the received data is the first data (YES in step S310), the device interface control section 232 determines in step S312 whether electric power supply to the VBUS terminal is stopped (second state). If the electric power supply is stopped (YES in step S312), the device interface control section 232 causes, in step S314, the USB host controller 218 to start supplying electric power to the VBUS terminals of all the USB ports (USB ports 212 and 214). The device interface control section 232 then starts communication with all the USB devices (the printer 300, and the TV tuner 310) (first state). If electric power is already being supplied (NO in step S312), step S314 is skipped (No in S312).

In step S316, the device interface control section 232 transmits a packet including data that indicates completion of startup of the USB devices to the computer that has transmitted the first data. This process is the same as the process in step S160 in FIG. 2. It should be noted that, in this embodiment, the virtual interface control section 132 (FIG. 1) of the computer starts sending a connection request to the USB devices (steps S170 to S190 in FIG. 2) not automatically but in response to the user's instruction. Thus, in this embodiment, the logical communication path (pipe) between the computer and the USB devices is not to be established without any instruction by the user. However, each USB device is in the first state. Accordingly, if any of the USB devices is to be used, the possible excessively long wait time until readying the USB device is complete can be reduced.

In subsequent step S318, the device interface control section 232 adds 1 to the number of active hosts. Thereafter, the procedure returns to step S300.

Diagram (B) in FIG. 4 shows a state where the first computer 100, which is in the state shown in diagram (A) in FIG. 4, starts up. In the case of a transition from the state shown in diagram (A) in FIG. 4 to that shown in diagram (B) in FIG. 4, when starting up, the first computer 100 transmits the first data to the device server 200. The device interface control section 232 executes a process in step S314 in the above-described flow to supply electric power to all the USB ports, and consequently each of the USB devices 300 and 310 transitions into the first state (state where each of the USB devices 300 and 310 is communicable with the device server 200). Further, in step S318, the device interface control section 232 (FIG. 1) updates the number of active hosts from “0” to “1”.

Diagram (C) in FIG. 4 shows a state where the second computer 100a, which is in the state shown in diagram (B) in FIG. 4, starts up. In the case of a transition from the state shown in diagram (B) in FIG. 4 to that shown in diagram (C) in FIG. 4, when starting up, the second computer 100a transmits the first data to the device server 200. The device interface control section 232 starts supplying electric power to all the USB ports, upon transition from the state shown in diagram (A) in FIG. 4 to that in diagram (B) in FIG. 4 in the above-described flow (step S314). Thus, the process of supplying electric power is skipped (step S314 in FIG. 5), here. Further, in step S318, the device interface control section 232 (FIG. 1) updates the number of active hosts from “1” to “2”.

The virtual interface control section 132 (FIG. 1) of a started one of the computer establishes a logical communication path with each USB device in response to an instruction by a user. This process is performed in a similar manner to those in steps S170 to S190 in FIG. 2. Accordingly, the computer can use the USB devices. Further, the virtual interface control section 132 can disconnect the logical communication path with each USB device in response to an instruction by the user. Accordingly, the other computer can use the USB devices. Preferably, the device interface control section 232 of the device server 200 maintains communication between the device server 200 and the USB devices even when receiving an instruction for disconnection from one of the computers. Accordingly, if the device server 200 receives a connection request from the other computer, the device server 200 can promptly start communication between the computer and the USB devices.

In the procedure shown in FIG. 5, if received data is the second data (NO in step S310, and YES in step S320), the device interface control section 232 updates the number of active hosts in step S322. That is, if the device server 200 receives the second data, the device interface control section 232 subtracts one from the number of active hosts.

In subsequent step S324, the device interface control section 232 determines whether the number of active hosts after update is “0”. If the number of active hosts after update is “0” (YES in step S324), the device interface control section 232 starts, in subsequent step S326, a process of disconnecting communication between the server machine 200 and all the USB devices. In step S328, the device interface control section 232 causes the USB host controller 218 to stop supplying electric power to the VBUS terminals of all the USB ports. These steps S326 and S328 are the same as steps S230 to S260 in FIG. 3. As described above, if the number of computers (active hosts) which are in active becomes “0”, the device interface control section 232 causes each USB devices to transition into the second state (state where the power consumption is reduced).

If the number of active hosts is not “0” (but one or more) (NO in step S324), the device interface control section 232 skips steps S326 and S328. As described above, if the number of the computers which are in active is one or more, the device interface control section 232 maintains the USB devices as being in the first state (state where the USB devices are communicable with the device server 200).

In subsequent step S329, the device interface control section 232 notifies the computer 100 that communication with the USB devices is completely disconnected. Step S329 is the same as step S270 in FIG. 3. This step S329 may be omitted. Thereafter, the procedure returns to step S300.

The diagram (D) in FIG. 4 shows a state where the first computer 100, which is in the state shown in diagram (C) in FIG. 4, is shut down. In the case of a transition from the state shown in diagram (C) in FIG. 4 to that shown in diagram (D) in FIG. 4, when shut down, the first computer 100 transmits the second data to the device server 200. The device interface control section 232 executes a process in step S322 in the above-described flow to update the number of active hosts from “2” to “1”, the device interface control section 232 skips steps S326 and S328, and keep supplying electric power to all the USB ports (NO in step S324).

The diagram (E) in FIG. 4 shows the state where the second computer 100a, which is in the state shown in diagram (D) in FIG. 4, is shut down. In the case of a transition from the state shown in diagram (D) in FIG. 4 to that shown in diagram (E) in FIG. 4, when shut down, the second computer 100a transmits the second data to the device server 200. The device interface control section 232 executes a process in step S322 in the above-described flow to update the number of active hosts, which is already updated to “1”, to “0”. The device interface control section 232 executes processes in steps S326 and S328 to stop supplying electric power to all the USB ports.

An example of the case where the received data is neither the first data nor the second data is a case where the device server 200 receives, from any of the computers, control data for controlling a USB device. In this case (NO in step S310, NO in step S320), the device interface control section 232 performs, in step S330, a process of, for example, transmitting control data to the USB devices. Thereafter, the procedure returns to step S300.

As described above, in this embodiment, if one or more of computers which are connected to a device server via a network are in active, the device server maintains the USB devices as being in the first state. Thus, in the case where there are a plurality of computers capable of utilizing USB devices, if at least one of the plurality of the computer is in active, the server machine maintains the USB devices as being in the first state. Accordingly, a possible excessively long wait time until readying the USB devices is complete can be reduced, regardless of which of the plurality of the computers is to use the USB devices. Further, if computers are all shut down, USB devices transition into the second state. Accordingly, it is possible to reduce power consumption while the USB devices are not being used.

Hereinafter, modifications of the above-described embodiments will be described.

### First Modification

In the above embodiments, the device interface control section 232 (FIG. 1) is able to use not only newly defined data but also various existing data, as the first data. For example, in the first embodiment, if the computer 100 is set to be connected to a network using the DHCP (Dynamic Host Configuration Protocol) at the time of its startup, a discover message compliant with the DHCP may be used as the first data. In this case, functions of creating first data and transmitting the first data from the computer 100 can be omitted. Thus, configuration of the operational state data transmitting section 134, for example, can be simplified. Accordingly, it is possible to prevent the configuration of the computer 100 from becoming excessively complex. If the network address (e.g., MAC address) of the computer 100 which is the transmission source of the discover message coincides with a preliminarily set address (referred to as a “permissible address”), the device interface control section 232 may use the discover message as the first data. In this case, the device interface control section 232 may set the permissible address in response to an instruction by a user.

Further, in the above-described first embodiment, the virtual interface control section 132 (FIG. 1) may establish a logical communication path between the computer 100 and the USB devices not automatically but in response to an instruction by the user. Further, in the above-described second embodiment, the virtual interface control section 132 may automatically establish logical communication paths between the computers and the USB devices. In this case, if a communication path is established between any one of the plurality of computers and the USB devices, the device interface control section 232 may prohibit establishment of a communication path between the other computer and the USB devices.

Further, in the above embodiments, various methods are adoptable as a method of specifying, by the virtual interface control section 132 and the operational state data transmitting section 134, the address of the device server 200 on the network NT. For example, the address of the device server 200 may be preliminarily set by the user. Alternatively, the operational state data transmitting section 134 or the virtual interface control section 132 may specify the address of the device server 200 by scanning the network NT.

### Second Modification

In the above embodiments and modification, the first state of the USB device, which is a peripheral device, is defined as the “state where the USB device is communicable with the device server 200”. The state may be embodied in various manners. For example, the first state may be a state where a USB device is able to change an operation mode depending on an operation mode switch instruction data received from the device interface control section 232 of the device server 200. Here, the operation mode switch instruction data means, for example, instruction data for switching the state of a USB device from one state (e.g., “address state”) to another state (e.g., “configured state”). Further, the first state may be a state where a USB device is able to execute a process (e.g., image printing) according to data (e.g., image data) received from the device interface control section 232. Further, the first state may be a state where data (e.g., an amount of mouse movement) received from a USB device is suppliable to the device interface control section 232. The device interface control section 232 may transmit data received from the USB devices to the computer 100 or 100a. Generally, if a USB device is supplied with electric power from the device server 200 via the USB port 212 or the 214, the state of the USB device is the “state where the USB device is communicable with the device server 200”, and thus corresponds to the first state.

The second state of the USB device is defined as the “state where the device interface control section 232 stops supplying electric power to the VBUS terminals of the USB ports 212 and 214, and power consumption by the USB device is reduced”. However, the second state is not limited to such a state, but any state may be applied as the second state if, in the state, power consumption of USB devices is lower than in the first state. For example, in the second state, the device interface control section 232 may supply electric power to USB devices via the USB ports 212 and 214. Further, the second state may be a state where USB devices are communicable with the server machine, or alternatively may be a state where USB devices are not communicable with the server machine.

Alternatively, for example, a suspend state in conformance to the USB standard may be adopted as the second state. In this case, a state (e.g., a “configured state”) where a USB is resumed from the suspend state may be adopted as the first state. In whichever state a USB device is in, either the suspend state or the resumed state, the USB device is in the state as being communicable with the device server 200. Further, if a USB device is in the suspend state, power consumption of the USB device is reduced as compared to a USB device which is in the resumed state.

Alternatively, the suspend state in conformance to the USB standard may be adopted as the first state, and a state where the device interface control section 232 stops supplying electric power to a USB device may be adopted as the second state.

### Third Modification

In the above embodiments and modifications, the device server 200 is connected to USB devices, which are peripheral devices, via the USB ports 212 and 214, which are device interfaces in conformance to the USB standard. However, the device interface is not limited to the interface in conformance to the USB standard. The device server may be provided with a device interface in conformance to another standard so as to be connected to a peripheral device in conformance to the standard. Examples of such a standard include the IEEE 1394 and the eSATA (External Serial ATA) standard. An interface in conformance to the IEEE 1394 standard has a power supply terminal similarly to the USB ports 212 and 214 which are interfaces in conformance to the USB standard, and thus, with the IEEE 1394 interface, it is possible to control a peripheral device through start and stop of electric power supply thereto. Further, the virtual interface control section 132 constitutes a virtual interface in conformance to the above-described standards. Alternatively, the device interface is not limited to a wired interface, but may be a wireless interface.

### Fourth Modification

In the above embodiments and modifications, general-purpose personal computers are employed as client machines which utilize the device server 200. However, the client machines are not limited to a general-purpose personal computer, but may be, for example, a personal digital assistant, a mobile phone, and an information processing device such as a tablet computer.

### Fifth Modification

In the above embodiments and modifications, the device server 200 may be connected to the network NT wiredly or wirelessly. The network port 210, which is a network interface of the device server 200 may be a wired interface, or a wireless interface. Similarly, the network interface of a client machine (e.g., the network port 110 of the computer 100) may be a wired interface or a wireless interface.

### Sixth Modification

In the above embodiments and modifications, the device interface control section 232 of the device server 200 is capable of executing various processes as a communication relay process between a client machine and a peripheral device. For example, the device interface control section 232 of the device server 200 may relay communication between a client machine and a peripheral device without processing the communication. Alternatively, based on communication (also referred to as device interface communication) between a server machine and a peripheral device, the device interface control section 232 may perform, with a client machine, communication that is different from the device interface communication in terms of the method and content.

### Seventh Modification

In the above embodiments and modifications, two peripheral devices, the printer 300 and the TV tuner 310 are exemplified. However, the types of peripheral devices are not limited to these, but any types of peripheral devices, such as scanners, hard disk drives may be employed. Further, the total number of peripheral devices connectable to the device server 200 is not limited to two, but may be one, or may be three or more.

### Eighth Modification

In the above embodiments and modifications, the respective components may be realized as appropriate by hardware, or may be realized by software. For example, although it has been described that the function of the device interface control section 232 is realized by the CPU 230 executing a program (software) stored in the nonvolatile memory 250, the function may be realized by a hardware circuit including a logic circuit.

Further, in the case where some or all of the functions of the present invention are realized by software, the software (computer program) may be provided in a manner as to be stored in a computer-readable storage medium. In the present invention, the “computer-readable storage medium” includes not only a portable storage medium such as a flexible disk and a CD-ROM, but also an internal storage device such as a RAM and a ROM, and an external storage device fixed to computers such as a hard disk.

While the invention has been described in detail, the foregoing description is in all aspects illustrative and not restrictive. It will be understood that numerous other modifications and variations can be devised without departing from the scope of the invention. For example, elements which are additional in view of the gist of the present invention may be omitted as appropriate. Further, it will be obvious that various modifications and vibrations other than the above-described modifications can be devised without departing from the scope of the present invention.

What is claimed is:

1. A system whereby a client machine uses a peripheral device, the system comprising a peripheral device, a server machine that connects to the peripheral device, and at least one client machine that connects to the server machine via a network;
the server machine including:
a device interface for connecting with the peripheral device,
a server machine network interface for connecting with a network, and
a device interface control section for relaying data communications between the client machine and the peripheral device via the device interface and the server machine network interface; and
the client machine including:
a client machine network interface for connecting with the network,
a virtual interface control section for, via the client machine network interface and the server machine network interface, communicating with the device interface control section and setting up a virtual device interface having an access configuration identical with that of the device interface, and
an operational state data transmitting section for transmitting predetermined first data to the server machine at launch of the client machine, and for transmitting predetermined second data to the server machine at shut-down of the client machine; wherein
the device interface control section is configured to
execute a first process if a first condition, including that the first data has been received from the client machine, is satisfied, of causing the peripheral device to transition into a first state in which the peripheral device is communicable with the server machine, and
execute a second process if a second condition, including that the second data has been received from the client machine, is satisfied, of causing the peripheral device to transition into a second state in which its power consumption is lower than that in the first state.

2. The system according to claim 1, wherein:
the device interface includes a power supply terminal for supplying electric power to the peripheral device; and
the device interface control section is configured to
execute as the first process a process of starting supply of electric power to the power supply terminal, and
execute as the second process a process of stopping supply of electric power to the power supply terminal.

3. The system according to claim 1, wherein the device interface control section is configured to:
execute the first process, with the first condition being that the first data has been received in a state in which the operational state of the peripheral device is the second state; and
execute the second process with the second condition being that a value in which, upon the second data being received, a count of times the second data has been received is subtracted from a count of times the first data has been received has become zero.

4. The system according to claim 2, wherein the device interface control section is configured to:
execute the first process, with the first condition being that the first data has been received in a state in which the operational state of the peripheral device is the second state; and
execute the second process with the second condition being that a value in which, upon the second data being received, a count of times the second data has been received is subtracted from a count of times the first data has been received has become zero.

5. A method whereby a client machine utilizes a peripheral device, in a system comprising a peripheral device, a server machine that connects to the peripheral device, and at least one client machine that connects to the server machine, the method comprising
at launch of the client machine:
a step of the client machine transmitting first data to the server machine;
a step of the server machine executing a first process, if a first condition, including that the first data has been received from the client machine, is satisfied, of causing the peripheral device to transition into a first state in which the peripheral device is communicable with the server machine; and
a step of the client machine setting up, through communication with the server machine, a virtual device interface having an protocol identical with that of a device interface included in the server machine; and
at shutdown of the client machine:
a step of the client machine transmitting second data to the server machine via the network; and
a step of the server machine executing a second process, if a second condition, including that the second data has been received from the client machine, is satisfied, of causing the peripheral device to transition into a second state in which its power consumption is lower than that in the first state.

6. A server machine that connects to a peripheral device, and that connects to a client machine via a network, the server machine comprising:
a device interface for connecting with the peripheral device;
a network interface for connecting with a network; and
a device interface control section configured to
relay data communications between the client machine and the peripheral device via the device interface and the server machine network interface, and
execute a first process, if a first condition, including that predetermined first data has been received from the client machine, is satisfied, of causing the peripheral device to transition into a first state in which the peripheral device is communicable with the server machine, and execute a second process, if a second condition, including that predetermined second data has been received from the client machine, is satisfied, of causing the peripheral device to transition into a second state in which its power consumption is lower than that in the first state.

7. The server machine according to claim 6, wherein the device interface control section uses, as the first data, a discover message that is transmitted by the client machine and is compliant with a dynamic host configuration protocol.
